(19) United States
(12) Patent Application Publication
(10) Pub. No.: US 2017/0308255 A1
(43) Pub. Date: Oct. 26, 2017

(54) CHARACTER-SELECTION BAND FOR CHARACTER ENTRY

(71) Applicant: Microsoft Technology Licensing, LLC, Redmond, WA (US)

(72) Inventor: Dhirendra Bhupati, Redmond, WA (US)

(73) Assignee: Microsoft Technology Licensing, LLC, Redmond, WA (US)

(21) Appl. No.: 15/138,036

(22) Filed: Apr. 25, 2016

(51) Int. Cl. G06F 3/0485; G06F 17/24; G06F 3/0488; G06F 3/0484; G06F 17/27; G06F 3/0482

(52) U.S. Cl. CPC G06F 3/0485; G06F 17/276; G06F 17/24; G06F 3/0482; G06F 3/04845; G06F 3/04842; G06F 3/04883

(57) ABSTRACT

A character entry machine includes a user interface presented via a display. The user interface includes a character-entry field and a fixed character-selection band displaying a one-dimensional array of a selectable subset of a plurality of circularly-scrollable characters. A character selection controller is configured to add a selected character to the character-entry field responsive to a selection input selecting the selected character from the selectable subset of the plurality of circularly-scrollable characters. A scroll controller is configured to change the selectable subset of the plurality of circularly-scrollable characters to a changed selectable subset of the plurality of circularly-scrollable characters responsive to a scroll input. The character selection controller is configured to add a subsequently selected character to the character-entry field responsive to a subsequent selection input selecting the subsequently selected character from the changed selectable subset of the plurality of circularly-scrollable characters.

### BACKGROUND

Computing devices often include graphical input interfaces allowing users to input commands, alter user interface elements, enter strings of characters, etc. Such graphical input interfaces may be controlled by a variety of suitable input devices, including keyboards, mice, dials, buttons, touch-sensitive displays, motion-tracking cameras, proximity sensors, etc.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A character entry machine includes a user interface presented via a display. The user interface includes a character-entry field and a fixed character-selection band displaying a one-dimensional array of a selectable subset of a plurality of circularly-scrollable characters. A character selection controller is configured to add a selected character to the character-entry field responsive to a selection input selecting the selected character from the selectable subset of the plurality of circularly-scrollable characters. A scroll controller is configured to change the selectable subset of the plurality of circularly-scrollable characters to a changed selectable subset of the plurality of circularly-scrollable characters responsive to a scroll input. The character selection controller is configured to add a subsequently selected character to the character-entry field responsive to a subsequent selection input selecting the subsequently selected character from the changed selectable subset of the plurality of circularly-scrollable characters.

### BRIEF DESCRIPTION OF THE DRAWINGS

FIG. 1 schematically shows an example character entry machine.

FIG. 2 schematically illustrates character selection and scrolling with the example character entry machine of FIG. 1.

FIG. 3 schematically shows an example character entry machine with a plurality of circularly-scrollable characters.

FIG. 4 schematically illustrates scrolling and character prediction with an example character entry machine.

FIG. 5 schematically illustrates scrolling and character prediction with an example character entry machine.

FIG. 6 schematically shows an example character entry machine.

FIG. 7 schematically shows an example computing device.

### DETAILED DESCRIPTION

Users of computing devices may frequently have need to enter characters (e.g., numbers, letters, symbols) into graphical user interfaces. To this end, users may make use of graphical input interfaces, which often take the form of touch-sensitive keyboards/keypads. However, such keyboards/keypads often require a substantial amount of screen space, and require the use of two hands. Accordingly, this disclosure is directed to a user interface including a fixed character-selection band, which displays a one-dimensional array of several selectable characters, and is scrollable in order to present different characters for selection. Such an interface may allow a user to easily and efficiently enter characters with a single hand, without using an undue amount of screen space.

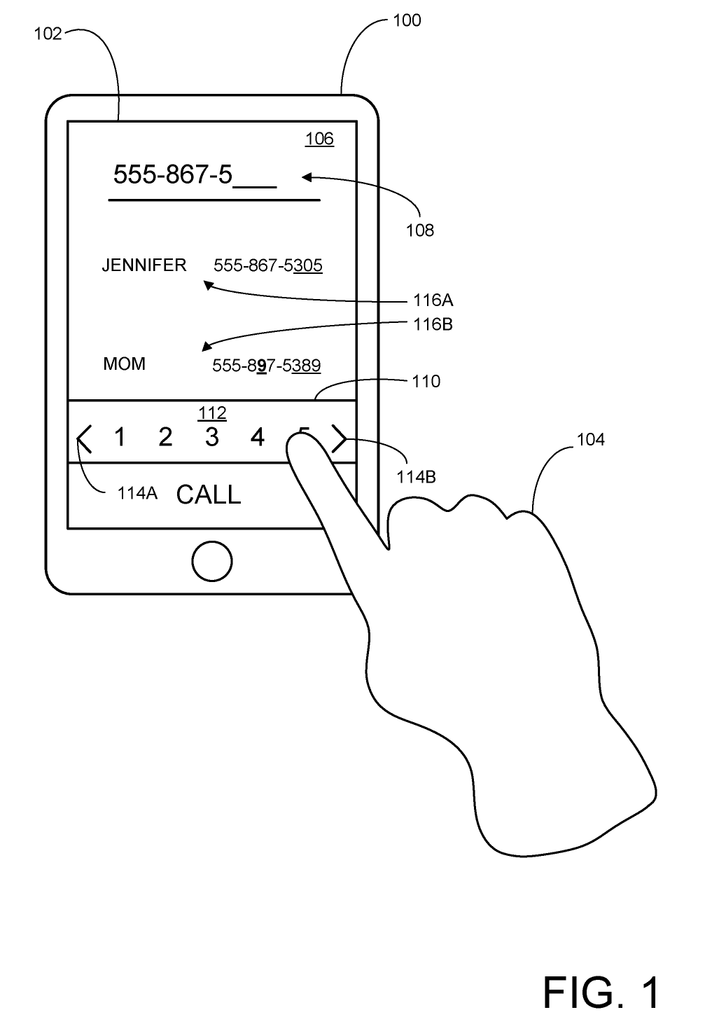

FIG. 1 schematically shows an example character entry machine 100. As shown, character entry machine 100 takes the form of a mobile computing device. However, a variety of different types of computing devices may be usable as a character entry machine. In particular, any computing device capable of presenting a user interface and receiving user input may be used as a character entry machine. For example, a character entry machine may take the form of a smartphone, tablet computer, laptop/desktop computer, wrist-wearable device, head mounted display device, etc.

Character entry machine 100 includes a display 102. In some implementations, display 102 may be a touch display. Display 102 may be virtually any type of display device suitable for presenting visual content.

As shown, display 102 is receiving touch input from a user hand 104. User hand 104 is a non-limiting example of a touch input source usable with character entry machine 100. In some implementations, display 102 may be configured to accept touch input from other sources, including passive styluses and/or active styluses, for example. In other implementations, a character entry machine may be configured to recognize hover input, voice input, air gestures (e.g., via a gesture tracking camera) and/or other user input modalities.

Display 102 is shown presenting a user interface 106. User interface 106 may include any information pertinent to/generated by any software applications, operating systems, and/or other logic currently running on character entry machine 100. User interface 106 may additionally include one or more interface elements which are manipulable by a user to provide input to character entry machine 100. For example, such interface elements may allow the user to alter/affect currently running software, change various settings of the character entry machine, change information currently displayed by the user interface, input user-specified information (e.g., enter characters), etc.

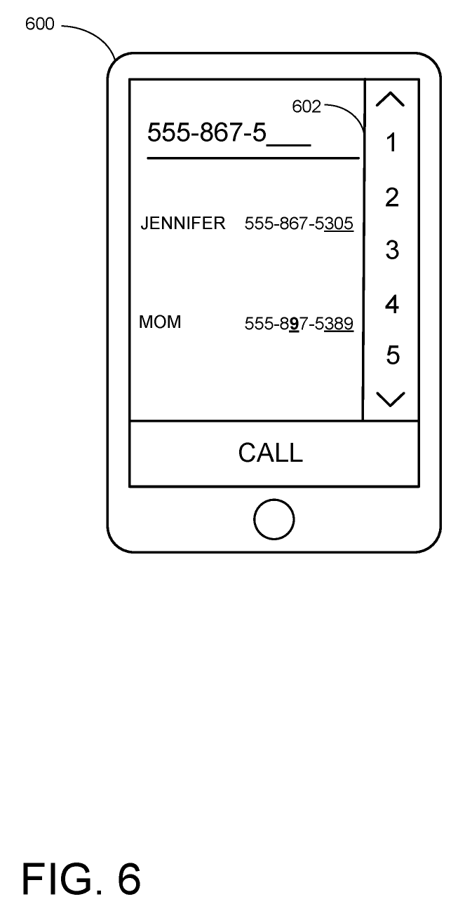

As shown in FIG. 1, user interface 106 includes a character-entry field 108 and a fixed character-selection band 110 displaying a one-dimensional array of characters 112. Fixed character-selection band 100 is shown parallel to a horizontal axis of user interface 106. Alternatively, fixed character-selection bands similar to band 110 may be vertically oriented, as will be illustrated below with respect to FIG. 6.

Fixed character-selection band 100 is shown extending from one edge of user interface 106 to the opposite edge. However, in other implementations, a fixed character-selection band may only occupy a portion of a user interface. For example, a fixed character-selection band may only be present at a location within a user interface which is easily accessible to the user's dominant hand.

Each of the characters displayed by fixed character-selection band 110 may be selectable by a user responsive to a selection input. A selection input may be performed in a number of ways. For example, the user may perform a touch input (e.g., with a digit or stylus) at a desired character, thereby selecting the character with a touch selection input. However, other input modalities may be used. For example, a user may vocally select a character, select a character by performing air gestures recognized by one or more cameras, etc. Upon selection, a character may be added to character-entry field 108. This is shown in FIG. 1, in which user hand 104 has selected a character (i.e., the number 5, partially occluded by user hand 104), and the selected character has been appended to previously entered characters “555867” in character-entry field 108.

Upon selection of a character and addition of the character to the character-entry field, the user may select subsequent characters from the selectable subset via subsequent selection inputs. Responsive to the subsequent selection inputs, the subsequently selected characters may be added to the character-entry field. This may be repeated as many times as is desired. In this manner, the user may input any suitable series of characters into a character entry machine, allowing the user to input telephone numbers, words, coordinates, etc. Each of the characters shown in character-entry field 108 may have been selected as described above, and the series of numbers shown in FIG. 1 may comprise a partial telephone number, for example.

As shown, fixed character-selection band 110 is displaying five characters, numbers 1-5 (the number 5 is partially occluded by user hand 104). However, other characters beyond those shown in FIG. 1 may be available for selection by a user. As such, the characters displayed by fixed character-selection band 110 may represent a selectable subset of a plurality of characters, where the selectable subset includes fewer total characters than the plurality of characters. In some implementations, the plurality of characters may include one-digit numbers ranging from 0-9. Additionally, or alternatively, the plurality of characters may include letters from the English alphabet, special characters (e.g., punctuation), letters/symbols used with other written languages, as well as any other characters which may be encoded/displayed by a computing device.

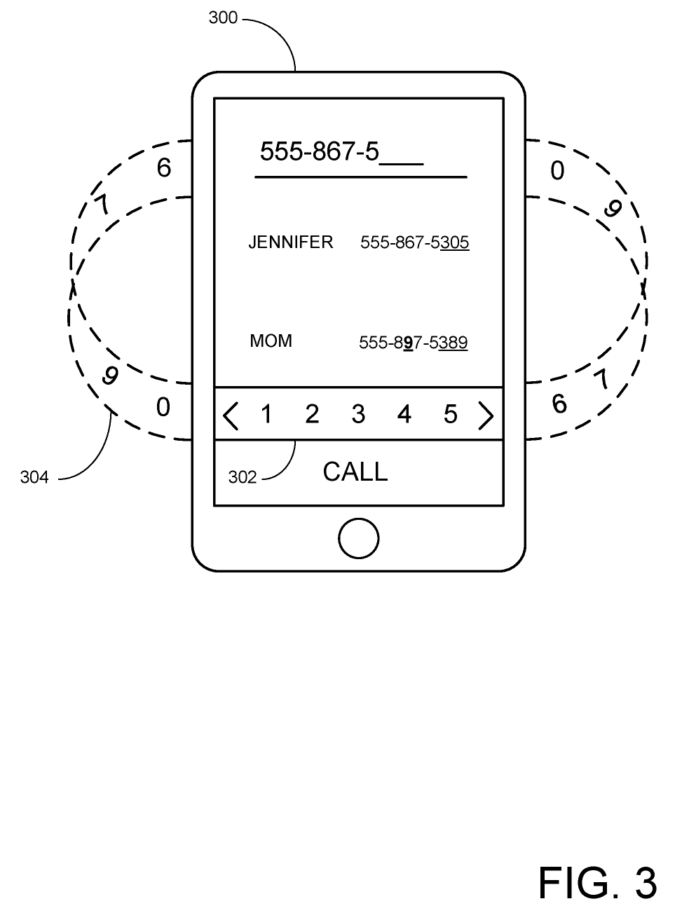

In order to select characters not presently displayed by the fixed character-selection band (i.e., not currently included in the selectable subset), the user may scroll the one-dimensional array of characters in order to change the selectable subset to include different characters, thereby becoming a changed selectable subset. This may be done responsive to a scroll input performed by the user. As scrolling occurs, each character displayed by the fixed character-selection band may incrementally move in the same direction. As characters reach an edge of the fixed character-selection band, they are removed from the selectable subset, while characters are simultaneously added to the selectable subset at the opposite end of the fixed character-selection band. In some implementation, the plurality of characters may be circularly-scrollable. In other words, the plurality of characters may infinitely repeat in the same order as the user scrolls. For example, in the case where the plurality of characters includes one-digit numbers ranging from 0-9, scrolling the one-dimensional array of characters beyond the number 9 may cause the numbers 0, 1, 2, etc., to be sequentially displayed. This is illustrated below with respect to FIG. 3.

A scroll input may be performed in a number of ways. For example, user interface 106 includes two scroll targets 114. Accordingly, scroll input may include any touch input received at one or more scroll targets of the user interface. Additionally, or alternatively, a scroll input may take the form of one or more gestures. For example, a user may perform a “swipe” gesture by contacting a surface of display 102, and sliding a finger/other input source across the surface. This may similarly result in scrolling of the plurality of circularly-scrollable characters. In such cases, a scroll input performed by a user may be characterized as a touch scroll input. In some implementations, a user may perform a scroll input via other input modalities. For example, a user may scroll the plurality of circularly-scrollable characters via voice commands, air gestures recognized by one or more cameras, physically tilting the display, etc.

Scroll input as described above may indicate a direction in which the circularly-scrollable characters are to move. For example, touch input received at scroll target 114A may cause one-dimensional array of characters 112 to scroll toward the left, changing the selectable subset. Similarly, touch input received at scroll target 114B may cause the one-dimensional array of characters to scroll toward the right, also changing the selectable subset. As another example, a user may perform a swipe gesture. For example, a swipe gesture which includes sliding a finger/stylus to the left may result in corresponding scrolling of the one-dimensional array of characters to the right. In other words, changing the selectable subset of the plurality of circularly-scrollable characters displayed by the fixed character-selection band may include incrementally moving characters of the selectable subset in a direction corresponding to a direction indicated by the scroll input.

Scroll input may change the selectable subset in a number of ways. For example, a single scroll input may cause each character displayed in the fixed character-selection band to move a pre-determined distance (expressed as a certain number of pixels, a certain distance relative to the user interface, etc.), move whichever distance is necessary to remove a predetermined number of characters from one side of the one-dimensional array and add the same number of characters to the other side, and/or replace all characters shown in the fixed character-selection band with other characters of the plurality. Additionally, or alternatively, a perceived magnitude of a scroll input may influence the extent to which characters move responsive to scroll input. For example, display 102 may be pressure-sensitive, and the character entry machine may be configured to scroll the plurality of circularly-scrollable characters to a greater extent in response to more forceful touch input. In the case of a swipe gesture, a user may slide a finger/stylus/other touch input source across the surface of the display over a slide distance with a slide speed, and the distance moved by each character may be equal/proportional to the slide distance and/or slide speed associated with the swipe gesture.

User interface 106 additionally includes two suggested character sequences 116. In FIG. 1, suggested character sequences 116 are suggested telephone numbers for a user's contacts. However, in other implementations, a user interface may present suggested character sequences taking any form. In general, any sequence of characters which a user is predicted to select may be presented to the user as a suggested character sequence. Suggested character sequences may be suggested at least in part based on a character selection history of a user of the character entry machine. In some implementations, a user may select (e.g., perform touch input directed at) a suggested character sequence in order to automatically add the characters included in the suggested character sequence to the character-entry field and/or to automatically perform an action associated with the selected character sequence (e.g., call a selected telephone number).

As shown in FIG. 1, user interface 106 is being presented as part of a dialer application. For example, the user interface shown in FIG. 1 may be usable to input and dial telephone numbers. However, character entry machines as described herein may be usable for a variety of purposes. For example, character entry machine 100 may be configured with functionality not related to telephone number dialing. Accordingly, the character entry approaches described herein may be applicable to user interfaces configured for purposes other than dialing telephone numbers. For example, a user may use a character entry machine to input text in a messaging application, addresses/places/coordinates in a map application, dates in a calendar application, etc. In each example, characters may be selected using a fixed character-selection band, as described above, while the layout of the user interface, as well as the specific information included therein, may change according to the desired functionality. As such, a fixed character-selection band may be implemented as a computing component (e.g., software, hardware, and/or firmware) usable with other applications/operating system components, and used to select/enter characters in a variety of scenarios.

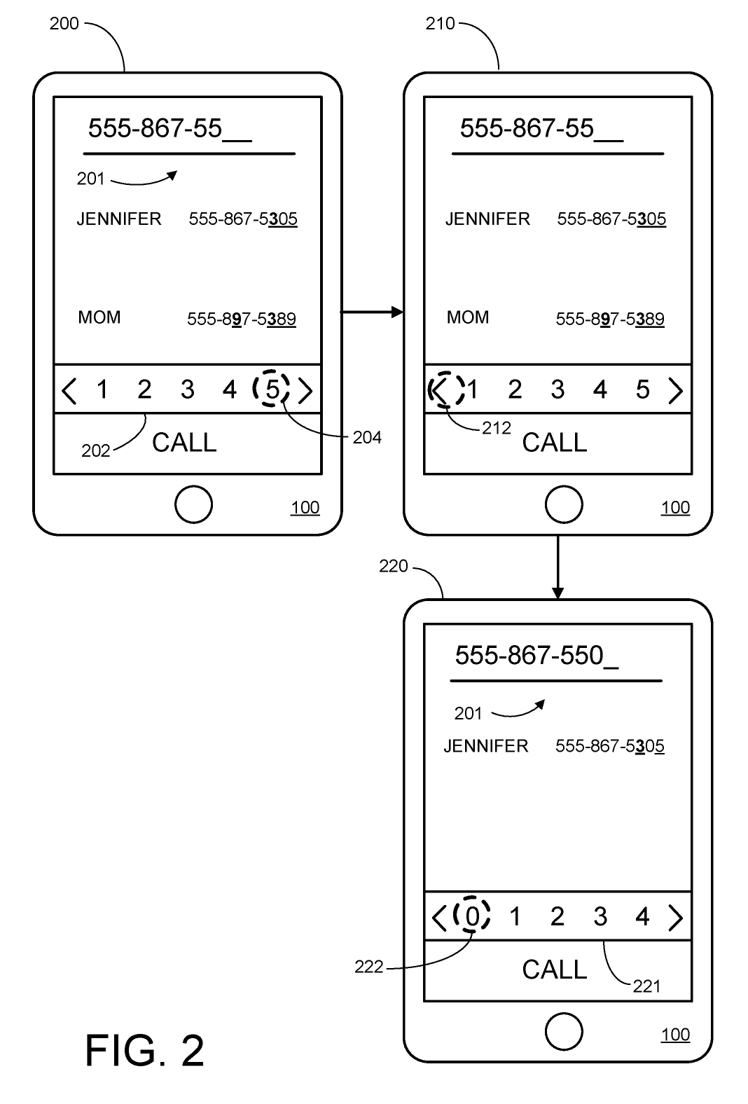

FIG. 2 schematically illustrates the process of selecting a character, changing a selectable subset, and selecting a subsequent character. At 200, FIG. 2 shows character entry machine 100 of FIG. 1 during selection of a character. As shown, character entry machine 100 is presenting a user interface including a character-entry field 201, as well as a fixed character-selection band displaying a selectable subset 202 of a plurality of circularly-scrollable characters. The dashed circle surrounding the number 5 indicates touch input 204 detected by character entry machine 100. In the illustrated example, touch input 204 is a proxy for user hand 104, shown in FIG. 1. Touch input 204 is a touch selection input selecting the number 5, which has been added to character-entry field 201.

At 210, character entry machine 100 is detecting touch input 212. Touch input 212 is directed at a scroll target of character entry machine 100, thereby comprising a touch scroll input. A touch scroll input, such as touch input 212, may cause the character entry machine to change the selectable subset of the plurality of circularly-scrollable characters displayed by the fixed character-selection band to a changed selectable subset.

At 220, touch input. 212 has resulted in scrolling of the plurality of circularly-scrollable characters. As such, character entry machine 100 is displaying a changed selectable subset 221 of the plurality of circularly-scrollable characters. Specifically, character positions have shifted such that the number 0 has been added to the selectable subset, while the number 5 has been removed.

Furthermore, character entry machine 100 is detecting touch input 222 at the number 0. Touch input 222 is a subsequent touch selection input. Accordingly, the subsequently selected character (i.e., the number 0) has been added to the character-entry field. In other words, the character entry machine may be configured to add a subsequently selected character to the character-entry field responsive to a subsequent touch selection input (e.g., touch input 222) selecting the subsequently selected character from the changed selectable subset of the plurality of circularly-scrollable characters displayed by the fixed character-selection band.

FIG. 3 schematically shows an example character entry machine 300. Character entry machine 300 is presenting a user interface which includes a fixed character-selection band 302 displaying a number of characters. As described above, characters displayed by fixed character-selection band 302 may be a selectable subset of a plurality of characters, which may be circularly-scrollable. This is schematically illustrated by the plurality of circularly-scrollable characters 304, which is visualized as a virtual band extending from fixed-character selection band 302 and wrapping around character entry machine 300. As shown, the plurality of circularly-scrollable characters repeats infinitely—in other words, as a user scrolls past the number 9, the numbers 0, 1, 2, etc., will be displayed.

A character entry machine may optionally be configured to identify a predicted character for a user. The predicted character may be identified in a number of suitable ways. For example, the predicted character may be identified based at least in part on a character selection history of a user of the character entry machine. This may include evaluating over time which characters a user typically selects under particular circumstances (e.g., the user's current physical location, a currently active application, other characters a user has recently selected) in order to predict which character(s) a user is likely to select next. The character entry machine may automatically change the selectable subset of the plurality of circularly-scrollable characters such that the predicted character is displayed in the changed selectable subset. Such automatic scrolling to the predicted character may be responsive to a scroll input or the previous character selection. After automatic scrolling, a user may select the predicted character, causing the predicted character to be added to the character-entry field. Alternatively, after automatically changing the selectable subset such that the predicted character is displayed, a user may select a different character, or perform additional scroll input, rather than select the predicted character. This may cause the character entry machine to identify and automatically display a second predicted character, or proceed as though no predicted character had been identified—i.e., scroll normally in accordance with the user's scroll input.

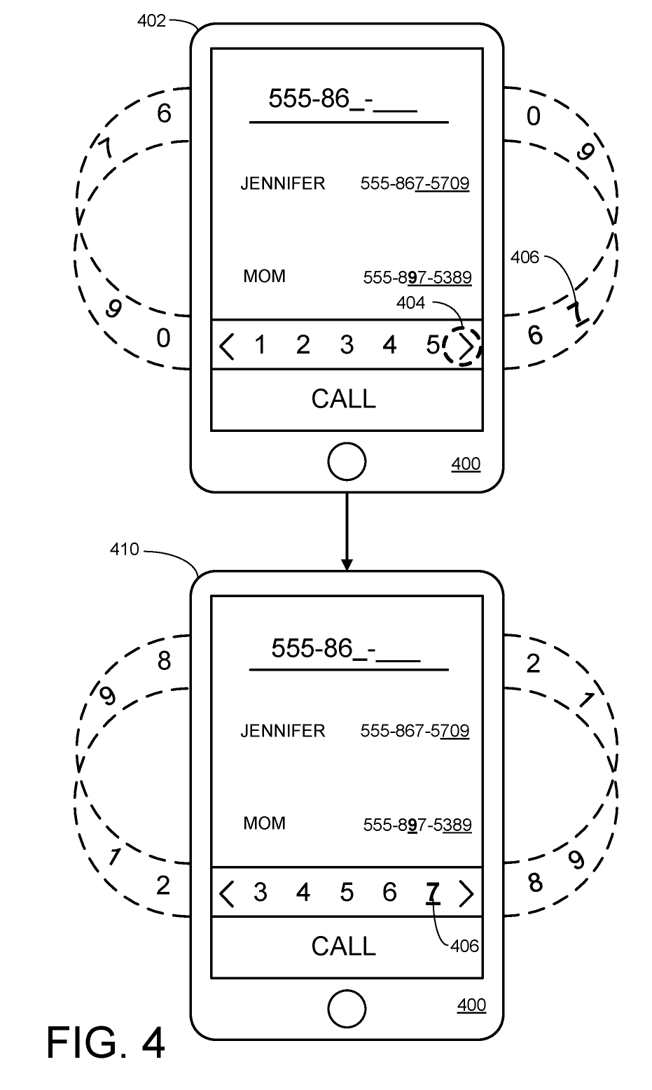

FIG. 4 schematically illustrates identification of a predicted character. FIG. 4 shows an example character entry machine 400, which is presenting a user interface including a fixed character-selection band. As with FIG. 3, the fixed character-selection band is displaying a selectable subset of a plurality of circularly-scrollable characters, where the plurality is visualized as a virtual band extending from the fixed character-selection band and wrapping around character entry machine 400. At 402, character entry machine 400 is detecting touch input 404. Touch input 404 is directed at a scroll target, and therefore is a touch scroll input. Also at 402, character entry machine 400 has identified character 406 (the number 7) as the predicted character.

At 410, responsive to touch input 404, the character entry machine has changed the selectable subset such that predicted character 406 is displayed in the changed selectable subset. In some implementations, the fixed character-selection band may be configured to display the predicted character differently from other characters of the plurality of circularly-scrollable characters. This is shown in FIG. 4, in which predicted character 406 is the only character of the plurality shown in bold and underline. However, in other implementations, a predicted character may be visually emphasized in other ways, or not at all. Visual emphasis of a predicted character as described above may allow a user to more easily and quickly identify and select characters predicted by a character entry machine.

Further, it may be easier for a user to select a predicted character when the predicted character is displayed at one or another side of the fixed character-selection band. Accordingly, the user interface may be configured to display the predicted character at a predetermined side of the user interface, and this may correspond to a selected hand of the user. The predetermined side may be user specified, and/or automatically chosen by the character entry machine. For example, if a user is right-handed, a predicted character may be displayed at a right side of a fixed character-selection band, for easy selection by the user's right hand. Additionally, or alternatively, the predicted character may be displayed at a side of the fixed character-selection band corresponding to a hand which the character entry machine is held in, determined via pressure sensors, for example. However, in other implementations, the character entry machine may display the predicted character in another position, such as a centered position. In general, the predicted character may automatically be displayed at a predetermined position that varies according to a current context of the character entry machine and/or a user of the character entry machine. Displaying the predicted character at a predetermined position may involve the character entry machine stopping scrolling of the circularly-scrollable characters when the predicted character is in the proper position, even under circumstances where scrolling would ordinarily continue.

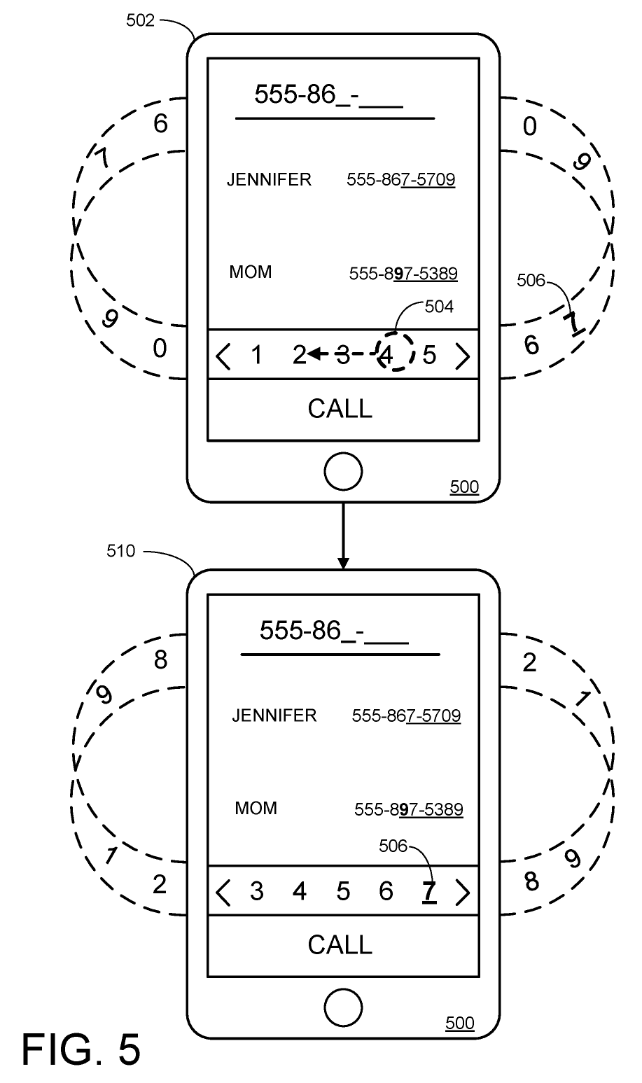

Similar to FIG. 4, FIG. 5 schematically illustrates identification of a predicted character. FIG. 5 shows an example character entry machine 500, which is presenting a user interface including a fixed character-selection band. As with FIGS. 3 and 4, the fixed character-selection band is displaying a selectable subset of a plurality of circularly-scrollable characters, where the plurality is visualized as a virtual band extending from the fixed character-selection band and wrapping around character entry machine 500. At 502, character entry machine 500 is detecting touch input 504. As shown, touch input 504 begins near the number 4, then moves left across the user interface. Accordingly, touch input 504 may be interpreted as a swipe gesture, and treated as a touch scroll input. Also at 502, character entry machine 500 has identified character 506 (the number 7) as the predicted character.

At 510, responsive to touch input 504, the character entry machine has changed the selectable subset such that predicted character 506 is displayed in the changed selectable subset. Similar to FIG. 4, the predicted character is displayed by the fixed character-selection band differently from other characters of the plurality of circularly-scrollable characters. Further, predicted character 506 optionally may be displayed at a side of the fixed character-selection band corresponding to a dominant hand of the user.

The specific user interfaces and interface elements described and illustrated herein are not intended to be limiting. In other implementations, user interfaces similar to those described herein may include more/less/different information, utilize different layouts and orientations, etc. For example, FIG. 6 schematically illustrates an example character entry machine 600, which is presenting a user interface including a fixed character-selection band 602. As with fixed character-selection bands described above, fixed character-selection band 602 is displaying a one-dimensional array of a selectable subset of a plurality of circularly-scrollable characters. However, in contrast to the fixed character-selection bands described above, the one-dimensional array of band 602 is parallel to a vertical axis of the user interface. Band 602 may still function similarly to other fixed character-selection bands described herein. In some implementations, a user may specify a preferred orientation for the fixed character-selection band, and/or the orientation of the band may automatically change as a user changes applications, interacts with an application, changes a physical orientation of the character entry machine, etc. For example, the user may configure character entry machine 600 to automatically display fixed character-selection band 602 at a location which is easily accessible by a dominant hand of the user.

In some implementations, the methods and processes described herein may be tied to a computing system of one or more computing devices. In particular, such methods and processes may be implemented as a computer-application program or service, an application-programming interface (API), a library, and/or other computer-program product.

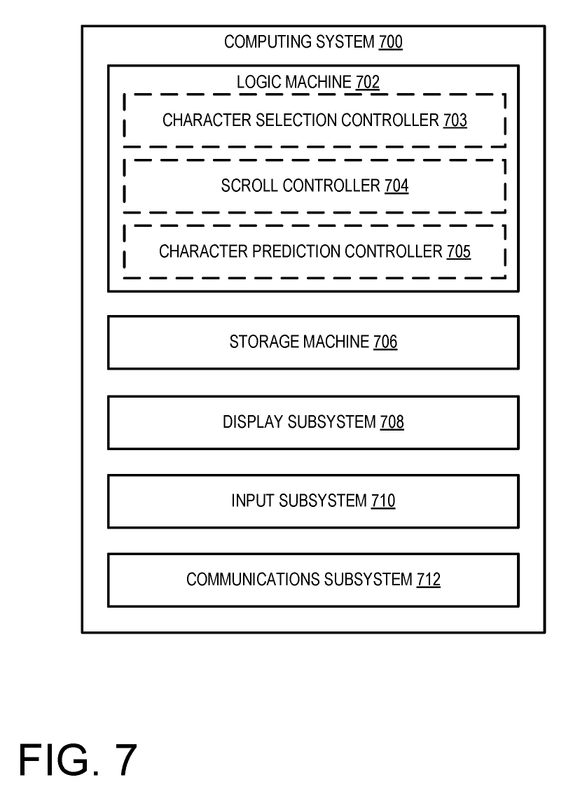

FIG. 7 schematically shows a non-limiting embodiment of a computing system 700 that can enact one or more of the methods and processes described above. Computing system 700 is shown in simplified form. Computing system 700 may take the form of one or more personal computers, server computers, tablet computers, home-entertainment computers, network computing devices, gaming devices, mobile computing devices, mobile communication devices (e.g., smart phone), and/or other computing devices.

Computing system 700 includes a logic machine 702 and a storage machine 706. Computing system 700 may optionally include a display subsystem 708, input subsystem 710, communication subsystem 712, and/or other components not shown in FIG. 7.

Logic machine 702 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Computing system 700 may additionally include a character selection controller 703, scroll controller 704, and character prediction controller 705. Such controllers may be used to perform the character selection, scrolling, and prediction functions described above. Specifically, character selection controller 703 may be configured to add a selected character to a character-entry field responsive to a touch selection input of a character displayed by a fixed character-selection band. Character selection controller 703 may additionally be configured to add a subsequently selected character to the character-entry field responsive to a subsequent touch selection input selecting the subsequently selected character from the changed selectable subset of the plurality of circularly-scrollable characters displayed by the fixed character-selection band. Scroll controller 704 may be configured to change a selectable subset of a plurality of circularly-scrollable characters to a changed selectable subset responsive to touch scroll input. Character prediction controller 705 may be configured to identify a predicted character and instruct scroll controller 703 to automatically change a selectable subset of a plurality of circularly-scrollable characters responsive to a touch scroll input such that the predicted character is displayed in the changed selectable subset.

Controllers 703, 704, and 705 as described above may be implemented as one or more hardware components. For example, controllers 703, 704, and 705 may be implemented as one or more processors/other logic machines, such as logic machine 702. Additionally, or alternatively, one or more of character selection controller 703, prediction controller 704, and character prediction controller 705 may be implemented as firmware, a user-installable software application, operating system component, etc.

Storage machine 706 includes one or more physical devices configured to hold instructions executable by the logic machine to implement the methods and processes described herein. When such methods and processes are implemented, the state of storage machine 706 may be transformed—e.g., to hold different data.

Storage machine 706 may include removable and/or built-in devices. Storage machine 706 may include optical memory (e.g., CD, DVD, HD-DVD. Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 706 may include volatile, nonvolatile, dynamic, static, read/write, read-only, random-access, sequential-access, location-addressable, file-addressable, and/or content-addressable devices.

It will be appreciated that storage machine 706 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 702 and storage machine 706 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 700 implemented to perform a particular function. In some cases, a module, program, or engine may be instantiated via logic machine 702 executing instructions held by storage machine 706. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 708 may be used to present a visual representation of data held by storage machine 706. This visual representation may take the form of a graphical user interface (GUI). As the herein described methods and processes change the data held by the storage machine, and thus transform the state of the storage machine, the state of display subsystem 708 may likewise be transformed to visually represent changes in the underlying data. Display subsystem 708 may include one or more display devices utilizing virtually any type of technology. Such display devices may be combined with logic machine 702 and/or storage machine 706 in a shared enclosure, or such display devices may be peripheral display devices.

When included, input subsystem 710 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 712 may be configured to communicatively couple computing system 700 with one or more other computing devices. Communication subsystem 712 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 700 to send and/or receive messages to and/or from other devices via a network such as the Internet.

In an example, a character entry machine comprises: a user interface presented via a display, the user interface including: a character-entry field; and a fixed character-selection band displaying a one-dimensional array of a selectable subset of a plurality of circularly-scrollable characters; a character selection controller configured to add a selected character to the character-entry field responsive to a selection input selecting the selected character from the selectable subset of the plurality of circularly-scrollable characters displayed by the fixed character-selection band; a scroll controller configured to change the selectable subset of the plurality of circularly-scrollable characters displayed by the fixed character-selection band to a changed selectable subset of the plurality of circularly-scrollable characters responsive to a scroll input; where the character selection controller is configured to add a subsequently selected character to the character-entry field responsive to a subsequent selection input selecting the subsequently selected character from the changed selectable subset of the plurality of circularly-scrollable characters displayed by the fixed character-selection band. In this example or any other example, the character entry machine further comprises a character prediction controller configured to identify a predicted character and instruct the scroll controller to automatically change the selectable subset of the plurality of circularly-scrollable characters such that the predicted character is displayed in the changed selectable subset. In this example or any other example, the fixed character-selection band is configured to display the predicted character differently from other characters of the plurality of circularly-scrollable characters. In this example or any other example, the character prediction controller identifies the predicted character based at least in part on a character selection history of a user of the character entry machine. In this example or any other example, the predicted character is displayed at a predetermined side of the fixed character-selection band. In this example or any other example, changing the selectable subset of the plurality of circularly-scrollable characters displayed by the fixed character-selection band includes incrementally moving characters of the selectable subset in a direction corresponding to a direction indicated by the touch scroll input. In this example or any other example, the scroll input comprises touch input at one or more scroll targets of the user interface. In this example or any other example, the plurality of circularly-scrollable characters includes one-digit numbers ranging from 0 to 9. In this example or any other example, the selectable subset of the plurality of circularly-scrollable characters includes fewer characters than the plurality of circularly-scrollable characters. In this example or any other example, the one-dimensional array is parallel to a horizontal axis of the user interface. In this example or any other example, the one-dimensional array is parallel to a vertical axis of the user interface. In this example or any other example, the user interface further includes one or more suggested character sequences suggested at least in part based on a character selection history of a user of the character entry machine.

In an example, a character entry machine comprises: a user interface presented via a touch display, the user interface including: a character-entry field; and a fixed character-selection band displaying a one-dimensional array of a selectable subset of a plurality of circularly-scrollable characters; a character selection controller configured to add a selected character to the character-entry field responsive to a touch selection input selecting the selected character from the selectable subset of the plurality of circularly-scrollable characters displayed by the fixed character-selection band; a scroll controller configured to change the selectable subset of the plurality of circularly-scrollable characters displayed in the one-dimensional array responsive to a touch scroll input; and a character prediction controller configured to identify a predicted character and instruct the scroll controller to automatically change the selectable subset of the plurality of circularly-scrollable characters responsive to the touch scroll input such that the predicted character is displayed in the changed selectable subset; where the character selection controller is configured to add the predicted character to the character-entry field responsive to a subsequent touch selection input selecting the predicted character from the changed selectable subset of the plurality of circularly-scrollable characters displayed by the fixed character-selection band. In this example or any other example, the fixed character-selection band is configured to display the predicted character differently from other characters of the plurality of circularly-scrollable characters. In this example or any other example, the character prediction controller identifies the predicted character based at least in part on a character selection history of a user of the character entry machine. In this example or any other example, the predicted character is displayed at a predetermined side of the fixed character-selection band. In this example or any other example, the touch scroll input comprises touch input at one or more scroll targets of the user interface. In this example or any other example, the one-dimensional array is parallel to a horizontal axis of the user interface. In this example or any other example, the user interface further includes one or more suggested character sequences suggested at least in part based on a character selection history of a user of the character entry machine.

In an example, a character entry machine comprises: a user interface presented via a touch display, the user interface including: a character-entry field; one or more suggested character sequences; and a fixed character-selection band oriented parallel to an axis of the user interface and displaying a one-dimensional array of a selectable subset of a plurality of circularly-scrollable characters; a character selection controller configured to add a selected character to the character-entry field responsive to a touch selection input selecting the selected character from the selectable subset of the plurality of circularly-scrollable characters displayed by the fixed character-selection band; a scroll controller configured to change the selectable subset of the plurality of circularly-scrollable characters displayed by the fixed character-selection band to a changed selectable subset of the plurality of circularly-scrollable characters responsive to a touch scroll input; and a character prediction controller configured to identify a predicted character based at least in part on a character selection history of a user of the character entry machine and instruct the scroll controller to automatically change the selectable subset of the plurality of circularly-scrollable characters responsive to the touch scroll input such that the predicted character is displayed in the changed selectable subset at a predetermined side of the fixed character-selection band corresponding to a selected hand of the user of the character entry machine; where the character selection controller is configured to add the predicted character to the character-entry field responsive to a subsequent touch selection input selecting the predicted character from the changed selectable subset of the plurality of circularly-scrollable characters displayed by the fixed character-selection band.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A character entry machine, comprising:
a user interface presented via a display, the user interface including:
a character-entry field; and
a fixed character-selection band displaying a one-dimensional array of a selectable subset of a plurality of circularly-scrollable characters;
a character selection controller configured to add a selected character to the character-entry field responsive to a selection input selecting the selected character from the selectable subset of the plurality of circularly-scrollable characters displayed by the fixed character-selection band;
a scroll controller configured to change the selectable subset of the plurality of circularly-scrollable characters displayed by the fixed character-selection band to a changed selectable subset of the plurality of circularly-scrollable characters responsive to a scroll input;
where the character selection controller is configured to add a subsequently selected character to the character-entry field responsive to a subsequent selection input selecting the subsequently selected character from the changed selectable subset of the plurality of circularly-scrollable characters displayed by the fixed character-selection band.

2. The character entry machine of claim 1, further comprising a character prediction controller configured to identify a predicted character and instruct the scroll controller to automatically change the selectable subset of the plurality of circularly-scrollable characters such that the predicted character is displayed in the changed selectable subset.

3. The character entry machine of claim 2, where the fixed character-selection band is configured to display the predicted character differently from other characters of the plurality of circularly-scrollable characters.

4. The character entry machine of claim 2, where the character prediction controller identifies the predicted character based at least in part on a character selection history of a user of the character entry machine.

5. The character entry machine of claim 2, where the predicted character is displayed at a predetermined side of the fixed character-selection band.

6. The character entry machine of claim 1, where changing the selectable subset of the plurality of circularly-scrollable characters displayed by the fixed character-selection band includes incrementally moving characters of the selectable subset in a direction corresponding to a direction indicated by the touch scroll input.

7. The character entry machine of claim 1, where the scroll input comprises touch input at one or more scroll targets of the user interface.

8. The character entry machine of claim 1, where the plurality of circularly-scrollable characters includes one-digit numbers ranging from 0 to 9.

9. The character entry machine of claim 1, where the selectable subset of the plurality of circularly-scrollable characters includes fewer characters than the plurality of circularly-scrollable characters.

10. The character entry machine of claim 1, where the one-dimensional array is parallel to a horizontal axis of the user interface.

11. The character entry machine of claim 1, where the one-dimensional array is parallel to a vertical axis of the user interface.

12. The character entry machine of claim 1, where the user interface further includes one or more suggested character sequences suggested at least in part based on a character selection history of a user of the character entry machine.

13. A character entry machine, comprising:
a user interface presented via a touch display, the user interface including:
a character-entry field; and
a fixed character-selection band displaying a one-dimensional array of a selectable subset of a plurality of circularly-scrollable characters;
a character selection controller configured to add a selected character to the character-entry field responsive to a touch selection input selecting the selected character from the selectable subset of the plurality of circularly-scrollable characters displayed by the fixed character-selection band;
a scroll controller configured to change the selectable subset of the plurality of circularly-scrollable characters displayed in the one-dimensional array responsive to a touch scroll input; and
a character prediction controller configured to identify a predicted character and instruct the scroll controller to automatically change the selectable subset of the plurality of circularly-scrollable characters responsive to the touch scroll input such that the predicted character is displayed in the changed selectable subset;
where the character selection controller is configured to add the predicted character to the character-entry field responsive to a subsequent touch selection input selecting the predicted character from the changed selectable subset of the plurality of circularly-scrollable characters displayed by the fixed character-selection band.

14. The character entry machine of claim 13, where the fixed character-selection band is configured to display the predicted character differently from other characters of the plurality of circularly-scrollable characters.

15. The character entry machine of claim 13, where the character prediction controller identifies the predicted character based at least in part on a character selection history of a user of the character entry machine.

16. The character entry machine of claim 13, where the predicted character is displayed at a predetermined side of the fixed character-selection band.

17. The character entry machine of claim 13, where the touch scroll input comprises touch input at one or more scroll targets of the user interface.

18. The character entry machine of claim 13, where the one-dimensional array is parallel to a horizontal axis of the user interface.

19. The character entry machine of claim 13, where the user interface further includes one or more suggested character sequences suggested at least in part based on a character selection history of a user of the character entry machine.

20. A character entry machine, comprising:
a user interface presented via a touch display, the user interface including:
a character-entry field;
one or more suggested character sequences; and
a fixed character-selection band oriented parallel to an axis of the user interface and displaying a one-dimensional array of a selectable subset of a plurality of circularly-scrollable characters;
a character selection controller configured to add a selected character to the character-entry field responsive to a touch selection input selecting the selected character from the selectable subset of the plurality of circularly-scrollable characters displayed by the fixed character-selection band;
a scroll controller configured to change the selectable subset of the plurality of circularly-scrollable characters displayed by the fixed character-selection band to a changed selectable subset of the plurality of circularly-scrollable characters responsive to a touch scroll input; and
a character prediction controller configured to identify a predicted character based at least in part on a character selection history of a user of the character entry machine and instruct the scroll controller to automatically change the selectable subset of the plurality of circularly-scrollable characters responsive to the touch scroll input such that the predicted character is displayed in the changed selectable subset at a predetermined side of the fixed character-selection band corresponding to a selected hand of the user of the character entry machine;
where the character selection controller is configured to add the predicted character to the character-entry field responsive to a subsequent touch selection input selecting the predicted character from the changed selectable subset of the plurality of circularly-scrollable characters displayed by the fixed character-selection band.
